(19) United States
(12) Patent Application Publication
(10) Pub. No.: US 2009/0231290 A1
(43) Pub. Date: Sep. 17, 2009

(54) SYSTEM AND METHOD FOR CONTROLLING AN ELECTRONIC DEVICE

(75) Inventor: XIANG-YU CHEN, Nanjing City (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/334,527

(22) Filed: Dec. 15, 2008

(30) Foreign Application Priority Data
Mar. 12, 2008 (CN) 200810300528.5

(51) Int. Cl. G06F 3/041

(52) U.S. Cl. 345/173

(57) ABSTRACT

An electronic device includes a display screen and a contact key on a front side and a touch panel on a back side. The electronic device further includes a system configured for controlling the electronic device via contact on the touch panel and contact of the contact key, and displaying corresponding actions via a cursor on the display screen.

### BACKGROUND

1. Field of the Invention

Embodiments of the present disclosure are related to device controlling systems and methods, and particularly to a system and method for controlling an electronic device.

2. Description of Related Art

Presently, electronic devices, such as personal digital assistants, global positioning system (GPS) consoles, or personal computers (PC), can use touch screens and display screens to allow input and output of data via contact therewith, increasing convenience for the user.

However, display screens of most electronic devices use liquid crystal display (LCD) technology, increasing device costs. Moreover, stylus operation on the LCD touch panel can deteriorate surface integrity thereof, resulting in reduction of lifespan of the LCD touch panel.

What is needed, therefore, is a system and method for controlling an electronic device to overcome the described limitations.

### BRIEF DESCRIPTION OF THE DRAWINGS

FIG. 1 is a block diagram of one embodiment of a front side of an electronic device with a display screen and a contact key.

FIG. 2 is a block diagram of one embodiment of a back side of the electronic device in FIG. 1 with a touch panel.

FIG. 3 is a block diagram of one embodiment of a system for controlling an electronic device via the touch panel and the contact key.

FIG. 4 is a flowchart of one embodiment of a method for controlling an electronic device.

### DETAILED DESCRIPTION OF CERTAIN INVENTIVE EMBODIMENTS

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

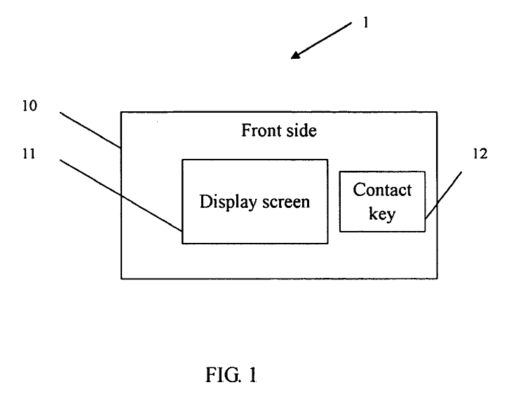

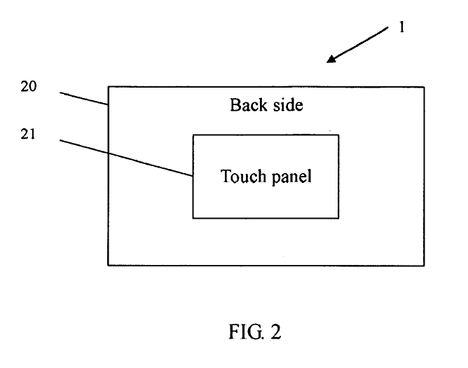

FIG. 1 is a block diagram of one embodiment of a front side 10 of an electronic device 1. FIG. 2 is a block diagram of a back side 20 of the electronic device 1 in FIG. 1. The front side 10 of the electronic device 1 includes a display screen 11 and a contact key 12. The back side 20 of the electronic device 1 includes a touch panel 21. In this embodiment, the electronic device 1 is a portable electronic device, but may alternatively be a query terminal device, a point of sale (POS) device, a retail cashier device, an automatic teller machine (ATM), or other devices without limiting the scope of the disclosure.

Depending on the embodiment, the display screen 11 may be, but is not limited to, a thin film transistor (TFT) screen, a thin film diode (TFD) screen, a ultra fine bright (UFB) screen, a super-twisted nematic (STN) screen, a color super-twisted nematic (CSTN) screen, a dual-layer super-twisted nematic (DSTN) screen, an organic light emitting diode (OLED) screen, or a field emitting diode (FED) screen. Additionally, the display screen 11 displays a cursor. The touch panel 21 comprises corresponding circuitry and a panel so as to enable one or more touches from an input device. The input device may be a human finger and/or a stylus, for example.

The contact key 12 and the touch panel 21 synchronously control actions of the cursor. Movements of the cursor on the display screen 11 are in response to contact on the touch panel 21. Contact with the contact key 12 confirms activation of the cursor, resulting in an instruction to active one or more instructions for an operating system and software applications of the electronic device 1. It may be understood that the any key in addition to the contact key 12 may be positioned on the front side of the electronic device 1 to control actions of the cursor synchronously with the touch panel 21.

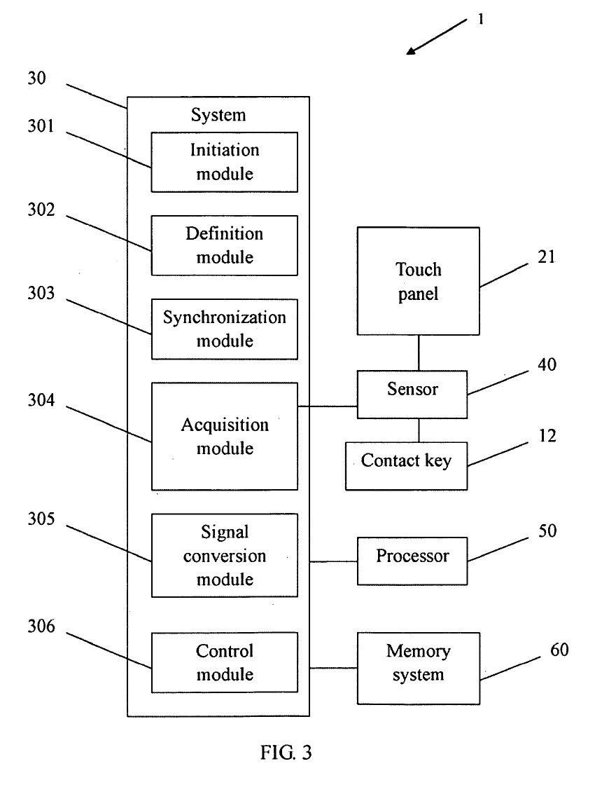

FIG. 3 is a block diagram of one embodiment of a system 30 for controlling the electronic device 1. In one embodiment, the electronic device 1 includes the contact key 12, the touch panel 21, a sensor 40, a processor 50, a memory system 60, and the system 30 for controlling the electronic device 1 to perform actions via the touch panel 21 and the contact key 12, and displaying the corresponding actions via the cursor displayed on the display screen 11. The sensor 40, connected to the touch panel 21 and the contact key 12, acquires analog signals of the contact on the touch panel 21 and the contact of the contact key 12.

The system 30 includes an initiation module 301, a definition module 302, a synchronization module 303, an acquisition module 304, a signal conversion module 305, and a control module 306. The modules 301, 302, 303, 304, 305 and 306 may execute one or more operations for the system 30. Additionally, the electronic device may comprise one or more specialized or general purpose processors, such as the processor 50 for executing the modules 301, 302, 303, 304, 305 and 306.

The initiation module 301 is configured for initiating display of the cursor on the display screen 11. The cursor provides control of the operating system and the software applications of the electronic device 1.

The definition module 302 is configured for defining a relationship between the contact on the touch panel 21 and a cursor movement on the display screen 11. For example, a left direction sliding on the touch panel 12 may define the cursor moving from the current position on the display screen 11 leftward. In one embodiment, data about the relationship may be stored in the memory system 60. The memory system 60 may be a hard disk drive, a flash memory, or any other kind of memory storage systems.

The definition module 302 is further configured for setting an activation of the cursor on the display screen 11 corresponding to the contact on the contact key 12. For example, the definition module 302 invokes a function corresponding to an icon highlighted by the cursor when the contact key 12 has been contacted.

The synchronization module 303 is configured for synchronizing the contact on the touch panel 21 and the contact of the contact key 12 with the corresponding cursor responses on the display screen 11. In one embodiment, the cursor responses comprise cursor movements, e.g., left-right shifts or up-down shifts on the display screen 11, and the activation of the cursor.

The acquisition module 304, connected to the sensor 40, is configured for acquiring first analog signals corresponding to the contact on the touch panel 21, and second analog signals corresponding to the contact of the contact key 12.

The signal conversion module 305 is configured for converting the first analog signals into first digital signals, and converting the second analog signals into second digital signals.

The control module 306 is configured for controlling the cursor movements according to the first digital signals, and controlling the activation of the cursor according to the second signals. In this embodiment, the cursor movements and the activation of the cursor provide instructions to operate an operating system and software applications of the electronic device 1.

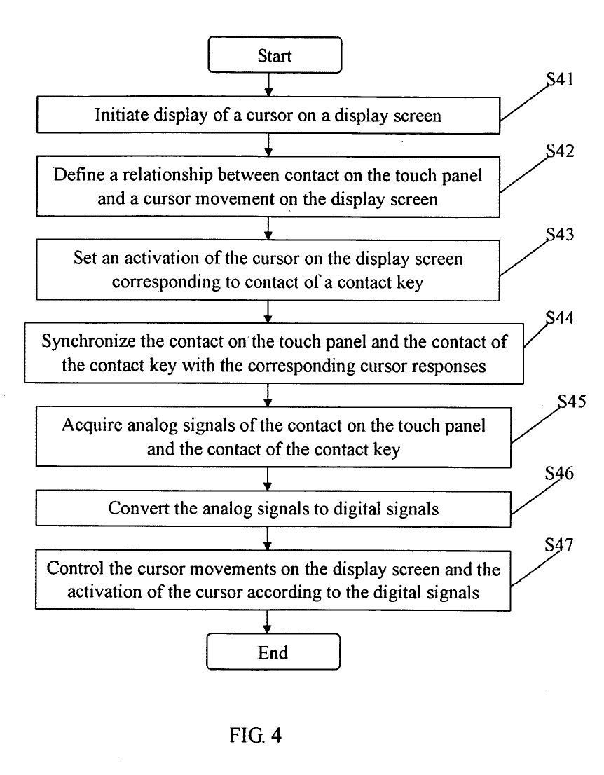

FIG. 4 is a flowchart of one embodiment of a method for controlling the electronic device 1 via the touch panel 21 and the contact key 12. Additional blocks may be added or deleted and blocks may be executed in a different order than that described without deviating from the spirit of the disclosure. First, in block S41, the initiation module 301 initiates the display of a cursor on the display screen 11 of the electronic device 1.

In block S42, the definition module 302 defines a relationship between contact on the touch panel 21 and a cursor movement on the display screen 11. As mentioned above, for example, a left direction sliding on the touch panel 12 may define the cursor moving from the current position on the display screen 11 leftward.

In block S43, the definition module 302 sets an activation of the cursor on the display screen 11 corresponding to contact of the contact key 12. Thus, when the cursor highlights an icon, such as a file folder on the display screen 11, if a user touches the contact key 12, the cursor will hit the file folder to display a sub-directory under the file folder.

In block S44, the synchronization module 303 synchronizes the contact on the touch panel 21 and the contact of the contact key 12 with the corresponding cursor responses on the display screen 11. As mentioned above, the cursor responses comprise cursor movements, e.g., left-right shifts or up-down shifts on the display screen 11, and the activation of the cursor.

In block S45, the acquisition module 304 acquires first analog signals of the contact on the touch panel 21, and/or second analog signals of the contact of the contact key 12. For example, the acquisition module 304 acquires the first analog signals of the left direction sliding on the touch panel 12.

In block S46, the signal conversion module 305 converts the first analog signals into first digital signals, and/or converts the second analog signals into second digital signals.

In block S47, the control module 306 controls the cursor movements according to the first digital signals, and controls the activation of the cursor according to the second signals. For example, the control module 306 controls the cursor moving from the current position on the display screen 11 leftward according to the first digital signals.

The above embodiments apply a touch panel on a backside of an electronic device, and an contact key on a front side of the electronic device. Thus, a user can synchronously control actions of a cursor displayed on a display screen of the electronic device via touches on the touch panel and the contact key. As a result, the display screen of the electronic device is protected from defacing by frequently touches. In addition, the user can user both hands to quickly control operations of the electronic device, especially when play games.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. An electronic device comprising a display screen and a contact key on a front side of the electronic device, and a touch panel on a back side of the electronic device, wherein the contact key and the touch panel synchronously control actions of a cursor displayed on the display screen through contact of the contact key and contact on the touch panel.

2. The electronic device as claimed in claim 1, further comprising:
a definition module configured for defining a relationship between the contact on the touch panel and a cursor movement on the display screen, and setting an activation of the cursor on the display screen corresponding to the contact of the contact key; and
a synchronization module configured for synchronizing the contact on the touch panel and the contact of the contact key with the corresponding cursor responses on the display screen.

3. The electronic device as claimed in claim 2, further comprising a sensor connected to the touch panel and the contact key, configured for acquiring analog signals of the contact on the touch panel and the contact of the contact key.

4. The electronic device as claimed in claim 3, further comprising:
an acquisition module configured for acquiring first analog signals corresponding to the contact on the touch panel and second analog signals corresponding to the contact of the contact key;
a signal conversion module configured for converting the first analog signals into first digital signals, and converting the second analog signals into second digital signals; and
a control module configured for controlling the cursor movements according to the first digital signals, and controlling the activation of the cursor according to the second signals.

5. The electronic device as claimed in claim 4, wherein the control module controls the cursor movements and the activation of the cursor to provide instructions to activate an operating system and software applications of the electronic device.

6. The electronic device as claimed in claim 1, wherein the electronic device is selected from the group consisting of a portable electronic device, a query terminal device, a point of sale (POS) device, a retail cashier device, and an automatic teller machine (ATM).

7. The electronic device as claimed in claim 1, wherein the display screen is selected from the group consisting of a thin film transistor (TFT) screen, a thin film diode (TFD) screen, a ultra fine bright (UFB) screen, a super-twisted nematic (STN) screen, a color super-twisted nematic (CSTN) screen, a dual-layer super-twisted nematic (DSTN) screen, an organic light emitting diode (OLED) screen, and a field emitting diode (FED) screen.

8. A computer-implemented method for controlling an electronic device, the electronic device comprising a display screen on a front side of the electronic device, the method comprising:
providing a touch panel on a back side of the electronic device and a contact key on a front side of the electronic device;
defining a relationship between contact on the touch panel and a cursor movement on the display screen;
setting an activation of the cursor on the display screen corresponding to contact of the contact key; and
synchronizing the contact on the touch panel and the contact of the contact key with the corresponding cursor responses on the display screen.

9. The method as claimed in claim 8, further comprising:
storing data about the relationships between the contact on the touch panel and the contact of the contact key and the corresponding cursor responses into a memory system of the electronic device.

10. The method as claimed in claim 8, wherein the electronic device further comprises a sensor connected to the touch panel and the contact key, configured for acquiring analog signals of the contact on the touch panel and the contact of the contact key.

11. The method as claimed in claim 10, further comprising:
acquiring first analog signals corresponding to the contact on the touch panel, and/or acquiring second analog signals corresponding to the contact of the contact key;
converting the first analog signals into first digital signals, and/or converting the second analog signals into second digital signals; and
controlling the cursor movements according to the first digital signals, and controlling the activation of the cursor according to the second signals.

12. The method as claimed in claim 11, wherein controlling the cursor movements and the activation provides instructions to active an operating system and software applications of the electronic device.

13. The method as claimed in claim 8, wherein the electronic device is selected from the group consisting of a portable electronic device, a query terminal device, a point of sale (POS) device, a retail cashier device, and an automatic teller machine (ATM).

14. The method as claimed in claim 8, wherein the display screen is selected from the group consisting of a thin film transistor (TFT) screen, a thin film diode (TFD) screen, a ultra fine bright (UFB) screen, a super-twisted nematic (STN) screen, a color super-twisted nematic (CSTN) screen, a dual-layer super-twisted nematic (DSTN) screen, an organic light emitting diode (OLED) screen, and a field emitting diode (FED) screen.

15. An electronic-readable medium having stored thereon instructions that, when executed by an electronic device, cause the electronic device to perform a method for controlling the electronic device, the electronic device comprising a display screen, the method comprising:
providing a touch panel on a back side of the electronic device and a contact key on a front side of the electronic device;
defining a relationship between contact on the touch panel and a cursor movement on the display screen;
setting an activation of the cursor on the display screen corresponding to contact of the contact key; and
synchronizing the contact on the touch panel and contact of the contact key with the corresponding cursor responses on the display screen.

16. The electronic-readable medium as claimed in claim 15, wherein the electronic device further comprises a sensor connected to the touch panel and the contact key, configured for acquiring analog signals of the contact on the touch panel and the contact of the contact key.

17. The electronic-readable medium as claimed in claim 16, wherein the method further comprises:
acquiring first analog signals of the contact on the touch panel, and/or acquiring second analog signals of the contact of the contact key;
converting the first analog signals into first digital signals, and/or converting the second analog signals into second digital signals; and
controlling the cursor movements according to the first digital signals, and controlling the activation of the cursor according to the second signals.

18. The electronic-readable medium as claimed in claim 17, wherein controlling the cursor movements and the activation provides instructions to active an operating system and software applications of the electronic device.

19. The electronic-readable medium as claimed in claim 15, wherein the electronic device is selected from the group consisting of a portable electronic device, a query terminal device, a point of sale (POS) device, a retail cashier device, and an automatic teller machine (ATM).

20. The electronic-readable medium as claimed in claim 15, wherein the display screen is selected from the group consisting of a thin film transistor (TFT) screen, a thin film diode (TFD) screen, a ultra fine bright (UFB) screen, a super-twisted nematic (STN) screen, a color super-twisted nematic (CSTN) screen, a dual-layer super-twisted nematic (DSTN) screen, an organic light emitting diode (OLED) screen, and a field emitting diode (FED) screen.
